(19) United States
(12) Patent Application Publication
(10) Pub. No.: US 2024/0086154 A1
(43) Pub. Date: Mar. 14, 2024

(54) LOGIC CIRCUIT FOR ANTI-CIRCULAR SHIFT-AND-ADD MULTIPLICATION

(71) Applicants: Siavash Bayat-sarmadi, Tehran (IR); Shahriar Hadayeghparast, Zanjan (IR); Shahriar Ebrahimi, Tehran (IR)

(72) Inventors: Siavash Bayat-sarmadi, Tehran (IR); Shahriar Hadayeghparast, Zanjan (IR); Shahriar Ebrahimi, Tehran (IR)

(73) Assignee: Sharif University of Technology, Tehran, OT (IR)

(21) Appl. No.: 18/515,422

(22) Filed: Nov. 21, 2023

Related U.S. Application Data
(63) Continuation-in-part of application No. PCT/IB2022/054756, filed on May 20, 2022.
(60) Provisional application No. 63/192,118, filed on May 24, 2021.

(51) Int. Cl. G06F 7/544; G06F 5/01; G06F 17/16

(52) U.S. Cl. CPC G06F 7/5443; G06F 5/01; G06F 17/16

(57) ABSTRACT

A logic circuit for anti-circular shift-and-add multiplication of an input vector and a binary vector. The logic circuit includes a plurality of input array pairs, a plurality of shift-and-add units, and an output datapath. A shift-and-add unit of the plurality of shift-and-add units is configured to generate a shift-and-add output of a plurality of shift-and-add outputs from an input array pair of the plurality of input array pairs at each clock cycle of the logic circuit. The output datapath is configured to generate an output vector by merging the plurality of shift-and-add outputs into the output vector. The output vector includes a segment of a multiplication result of the input vector and the binary vector.

### CROSS-REFERENCE TO RELATED APPLICATION

This application is a continuation-in-part of PCT/IB2022/054756 filed on May 20, 2022, which claims the benefit of priority from U.S. Provisional Patent Application Ser. No. 63/192,118, filed on May 24, 2021, and entitled “HIGH-SPEED POST-QUANTUM CRYPTO-PROCESSOR BASED ON RISC-V ARCHITECTURE FOR IOT,” which are both incorporated herein by reference in their entirety.

### TECHNICAL FIELD

The present disclosure generally relates to transformers, and particularly, to current transformers.

### BACKGROUND

A number of users and connected devices in an internet of things (IoT) network is growing exponentially through time. Due to the emergence of information-critical applications such as e-health and smart homes, it may be necessary to ensure the confidentiality of data and user privacy by establishing secure communication among IoT nodes.

One of main building blocks of secure communication may include underlying public-key encryption (PKE) schemes, such as Rivest-Shamir-Adleman (RSA) and elliptic curve cryptography (ECC). Classical PKE schemes may have high computational overhead and therefore may not be suitable for resource-constrained devices in IoT. Hence, it may be necessary to employ new PKE schemes to facilitate secure communication of IoT networks in the post-quantum era. Lattice-based cryptography and especially learning with errors (LWE) and its variants may have the lowest computational complexity among current post-quantum PKE schemes. Therefore, they may be more suitable for resource-constrained devices in IoT.

Recently, a new variant of LWE, namely Ring-BinLWE, has been proposed that utilizes binary error and private keys instead of state-of-the-art Gaussian ones. This may result in smaller ciphertext and key sizes, and lower complexity for IoT applications by decreasing communication costs. However, straight-forward software implementations of RingBinLWE may have a low speed and throughput due to a high computational cost of shift- and add multiplication in RingBinLWE. There is, therefore, a need for a hardware implementation of shift-and-add multiplication that may yield a lower computation cost and lower resource utilization.

### SUMMARY

This summary is intended to provide an overview of the subject matter of this patent, and is not intended to identify essential elements or key elements of the subject matter, nor is it intended to be used to determine the scope of the claimed implementations. The proper scope of this patent may be ascertained from the claims set forth below in view of the detailed description below and the drawings.

In one general aspect, the present disclosure is directed to an exemplary logic circuit for anti-circular shift-and-add multiplication of an input vector and a binary vector. An exemplary logic circuit may include a plurality of input array pairs, a plurality of shift-and-add units, and an output datapath. An exemplary shift-and-add unit of the plurality of shift-and-add units may generate a shift-and-add output of a plurality of shift-and-add outputs from an input array pair of the plurality of input array pairs at each clock cycle of the logic circuit. An exemplary output datapath may generate an output vector by merging the plurality of shift-and-add outputs into the output vector. An exemplary output vector may include a segment of a multiplication result of the input vector and the binary vector. In an exemplary embodiment, the input array pair may include an input array and a complemented input array. An exemplary input array may include a plurality of subarrays. An exemplary complemented input array may include a plurality of complemented subarrays.

An exemplary logic circuit may further include an input datapath. An exemplary input datapath may receive successive segments of the input vector at each clock cycle of the logic circuit. In an exemplary embodiment, each of the successive segments may include eight successive bits of the input vector.

An exemplary input datapath may include a plurality of two's complement converters. An exemplary two's complement converter of the plurality of two's complement converters may be generate a two's complement segment of a plurality of two's complement segments from a segment of the successive segments.

An exemplary logic circuit may further include a comparator. An exemplary comparator may compare a first index with a second index, generate a first selection value at a comparator output responsive to the first index being larger than the second index, generate a second selection value at the comparator output responsive to the first index being equal to the second index, and generate a third selection value at the comparator output responsive to the first index being smaller than the second index.

An exemplary logic circuit may further include an input multiplexer. An exemplary input multiplexer may generate a plurality of selected bits from the binary vector based on the comparator output. An exemplary logic circuit may further include a plurality of input registers. An exemplary input register of the plurality of input registers may include a plurality of input bits. In an exemplary embodiment, each of the plurality of input bits may be coupled to a selected bit of the plurality of selected bits and may receive a value of the selected bit.

An exemplary logic circuit may further include an AND gate array. An exemplary AND gate array may include a plurality of AND gate pairs. An exemplary AND gate pair of the plurality of AND gate pairs may include a first AND gate and a second AND gate. An exemplary first AND gate may generate a subarray of the plurality of subarrays by performing a bitwise AND operation on the segment and a value of the input register. An exemplary second AND gate may generate a complemented subarray of the plurality of complemented subarrays by performing a bitwise AND operation on the two's complement segment and the input register.

An exemplary shift-and-add unit may include a first adder unit, a second adder unit, a third adder unit, a fourth adder unit, an output register of a plurality of output registers, and a shift-and-add multiplexer. An exemplary first adder unit may generate a first adder output by summing values of each of the plurality of subarrays. An exemplary second adder unit may generate a second adder output based on values of the plurality of subarrays and the plurality of complemented subarrays. An exemplary third adder unit may generate a third adder output by summing values of each of the plurality of complemented subarrays. An exemplary fourth adder unit may include a first adder input and a second adder input. In an exemplary embodiment, the fourth adder unit may to generate the shift-and-add output by adding the first adder input and the second adder input.

An exemplary output register may store a value of the shift-and-add output and load the value of the shift-and-add output to the first adder input once at each clock cycle of the logic circuit. An exemplary shift-and-add multiplexer may load the first adder output to the first adder input responsive to the comparator output being equal to the first selection value, load the second adder output to the first adder input responsive to the comparator output being equal to the second selection value, and load the third adder output to the first adder input responsive to the comparator output being equal to the third selection value.

An exemplary logic circuit may further include a first verification multiplexer and a second verification multiplexer. An exemplary first verification multiplexer may load the successive segments to the input datapath responsive to a verification bit being equal to a first binary value and load values of the plurality of shift-and-add outputs to the input datapath responsive to the verification bit being equal to a second binary value. An exemplary second verification multiplexer may load values of each shift-and-add output of the plurality of shift-and-add outputs to a respective output register of the plurality of output registers responsive to the verification bit being equal to the first binary value and load each respective value of each of the successive segments to a respective output register of the plurality of output registers responsive to the verification bit being equal to the second binary value. In an exemplary embodiment, a value of the verification bit may be complemented once at each clock cycle of the logic circuit.

An exemplary logic circuit may further include an XOR gate. An exemplary XOR gate may generate a verification output by performing an XOR operation on two successive values of the output vector. In an exemplary embodiment, the two successive values may be generated at the output vector at two successive clock cycles of the logic circuit.

Other exemplary systems, methods, features and advantages of the implementations will be, or will become, apparent to one of ordinary skill in the art upon examination of the following figures and detailed description. It is intended that all such additional systems, methods, features and advantages be included within this description and this summary, be within the scope of the implementations, and be protected by the claims herein.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1A shows a scheme of shift-and-add multiplication in a binary learning with errors over ring (Ring-BinLWE) scheme, consistent with one or more exemplary embodiments of the present disclosure.

FIG. 1B shows a scheme of required calculations for anti-circular shift-and-add multiplication at the beginning of a quadruple selection of coefficients, consistent with one or more exemplary embodiments of the present disclosure.

FIG. 1C shows a scheme of required calculations for anti-circular shift-and-add multiplication at the end of a quadruple selection of coefficients, consistent with one or more exemplary embodiments of the present disclosure.

FIG. 2A shows a schematic of a logic circuit for anti-circular shift-and-add multiplication of an input vector and a binary vector, consistent with one or more exemplary embodiments of the present disclosure.

FIG. 2B shows a schematic of an input datapath, consistent with one or more exemplary embodiments of the present disclosure.

FIG. 2C shows a schematic of an input register, consistent with one or more exemplary embodiments of the present disclosure.

FIG. 2D shows a schematic of an AND gate array, consistent with one or more exemplary embodiments of the present disclosure.

FIG. 2E shows a schematic of an AND gate pair, consistent with one or more exemplary embodiments of the present disclosure.

FIG. 2F shows a schematic of a shift-and-add unit, consistent with one or more exemplary embodiments of the present disclosure.

FIG. 3 shows a schematic of a fault detection unit, consistent with one or more exemplary embodiments of the present disclosure.

FIG. 4 shows a schematic of an XOR gate loaded with two inputs, consistent with one or more exemplary embodiments of the present disclosure.

FIG. 5 shows a high-level functional block diagram of a computer system, consistent with one or more exemplary embodiments of the present disclosure.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

The following detailed description is presented to enable a person skilled in the art to make and use the methods and devices disclosed in exemplary embodiments of the present disclosure. For purposes of explanation, specific nomenclature is set forth to provide a thorough understanding of the present disclosure. However, it will be apparent to one skilled in the art that these specific details are not required to practice the disclosed exemplary embodiments. Descriptions of specific exemplary embodiments are provided only as representative examples. Various modifications to the exemplary implementations will be readily apparent to one skilled in the art, and the general principles defined herein may be applied to other implementations and applications without departing from the scope of the present disclosure. The present disclosure is not intended to be limited to the implementations shown, but is to be accorded the widest possible scope consistent with the principles and features disclosed herein.

Herein is disclosed an exemplary logic circuit for anti-circular shift-and-add multiplication. An exemplary logic circuit may calculate a multiplication result of a binary vector and an input vector that may include a number of coefficients. An exemplary logic circuit may obtain a given number of segments of the multiplication result at each clock cycle. Each exemplary segment may be calculated by a separate unit of the logic circuit at each clock cycle according to one of three summation scenarios of the anti-circular shift-and-add multiplication. Exemplary scenarios may include pure addition, pure subtraction, and a mixture of addition and subtraction of selected coefficients. Each scenario may be implemented by a separate adder of the logic circuit. As a result, a given series of coefficients may be summed according to one of the three scenarios at each clock cycle to update a corresponding segment of the multiplication result. Therefore, different segments of the multiplication result may be simultaneously calculated using separate units, so that the speed of anti-circular shift-and-add multiplication may be significantly increased.

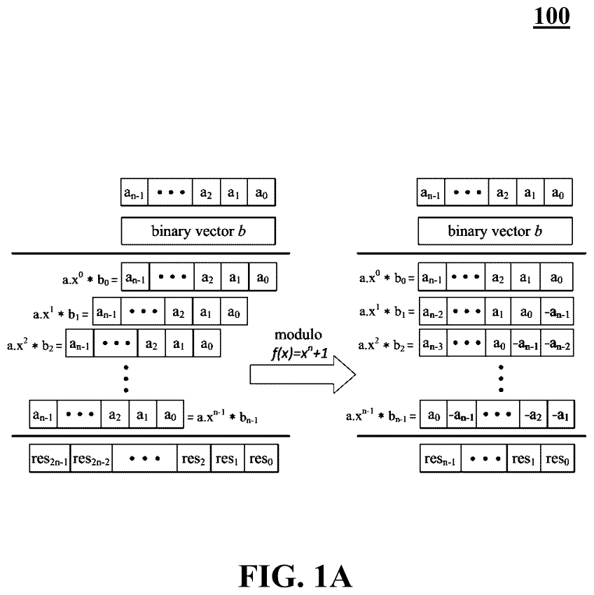

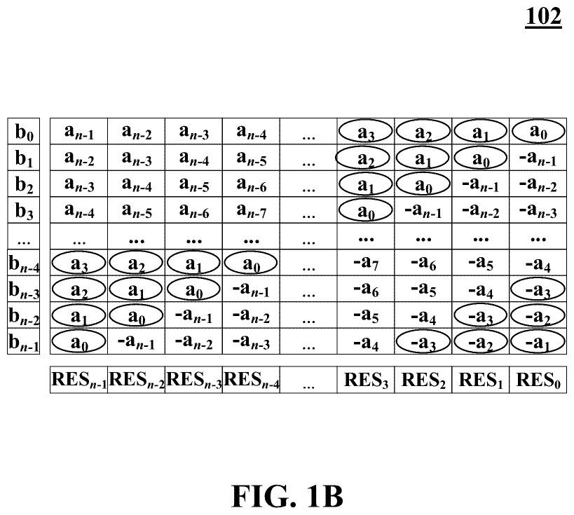

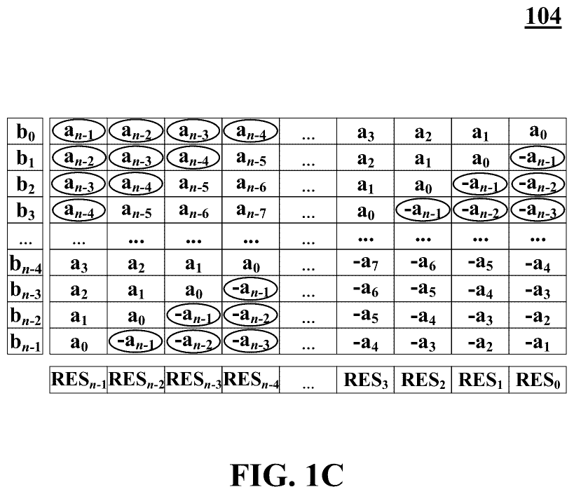

FIG. 1A shows a scheme 100 of shift-and-add multiplication in a binary learning with errors over ring (Ring-BinLWE) scheme, consistent with one or more exemplary embodiments of the present disclosure. In an exemplary Ring-BinLWE scheme 100, a multiplicand a may be a normal vector in a polynomial ring R_{q} with modulo xⁿ+1 and a multiplier b may be an n-bit binary vector. In this polynomial ring, a shift operation transforms into an anti-circular rotation of the ring elements. Each exemplary operand of add units in a shift-and-add operation may have an 8-bit length. In an exemplary embodiment, every coefficient's value may be included in each dimension of final result (RES) registers. Some exemplary coefficients may be employed inversely due to an anti-circular rotation property of the ring R_{q}.

FIG. 1B shows a scheme 102 of required calculations for anti-circular shift-and-add multiplication at a beginning of a quadruple selection of coefficients, consistent with one or more exemplary embodiments of the present disclosure. FIG. 1C shows a scheme 104 of required calculations for anti-circular shift-and-add multiplication at the end of a quadruple selection of coefficients, consistent with one or more exemplary embodiments of the present disclosure. Selected coefficients are distinguished in FIGS. 1B and 1C by drawing circles around corresponding indices.

Referring to FIGS. 1B and 1C, there may be three exemplary scenarios when coefficients are selected in a quadruple manner. In a first scenario, all selected coefficients may be summed. This is shown in FIG. 1B during the calculation of RES₃ to RESₙ₋₁. A summation of all selected coefficients may accumulate to corresponding results in an exemplary vector RES. In a second scenario, a mixed set of summation and subtraction may be formed. This scenario is noticeable in both FIGS. 1B and 1C during calculations of RES₀ to RES₂ and RESₙ₋₄ to RESₙ₋₂, respectively. In a third scenario, all selected coefficients may be subtracted, as shown during calculations of RES₀ to RESₙ₋₅ in FIG. 1C. In an exemplary embodiment, a subtraction of all selected coefficients may accumulate to corresponding results in vector RES.

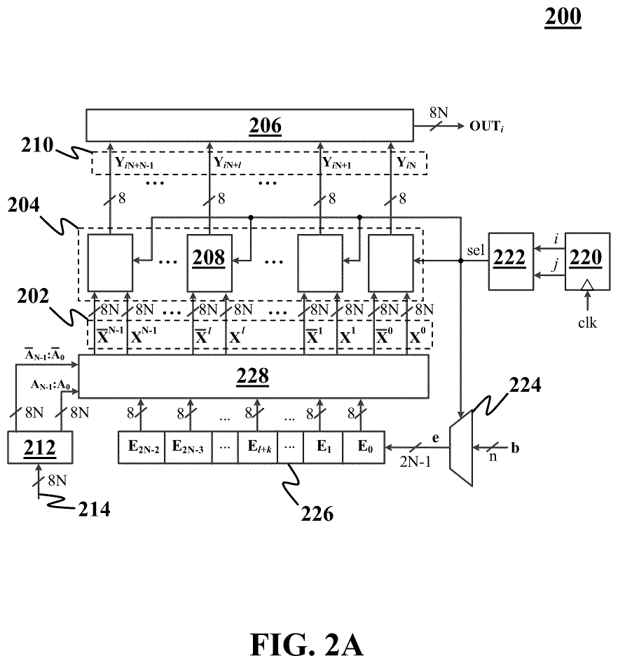

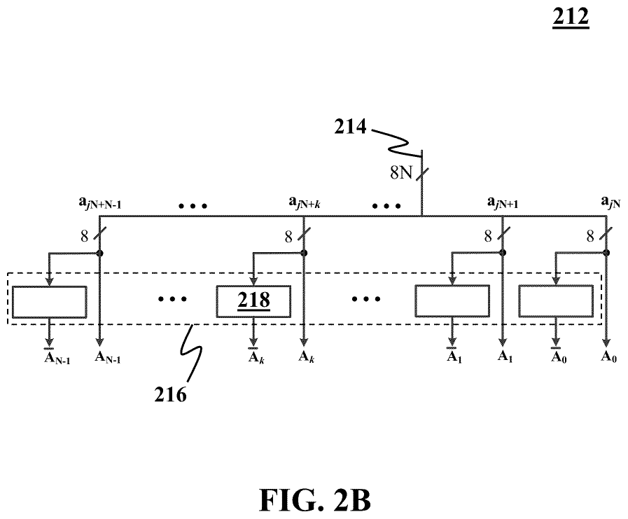

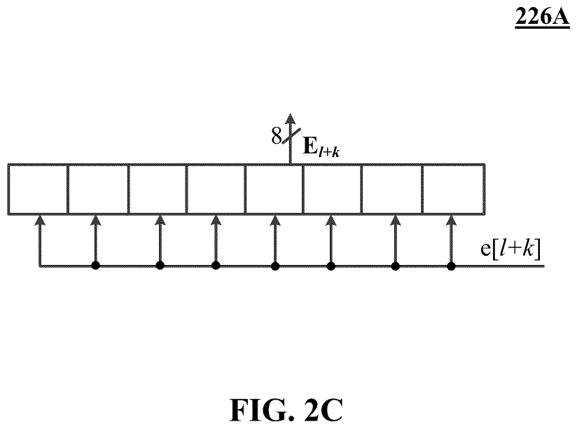

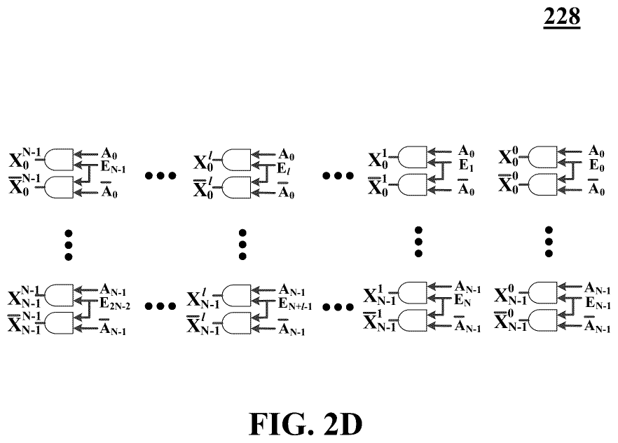

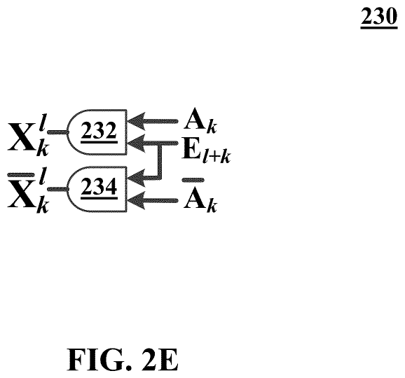

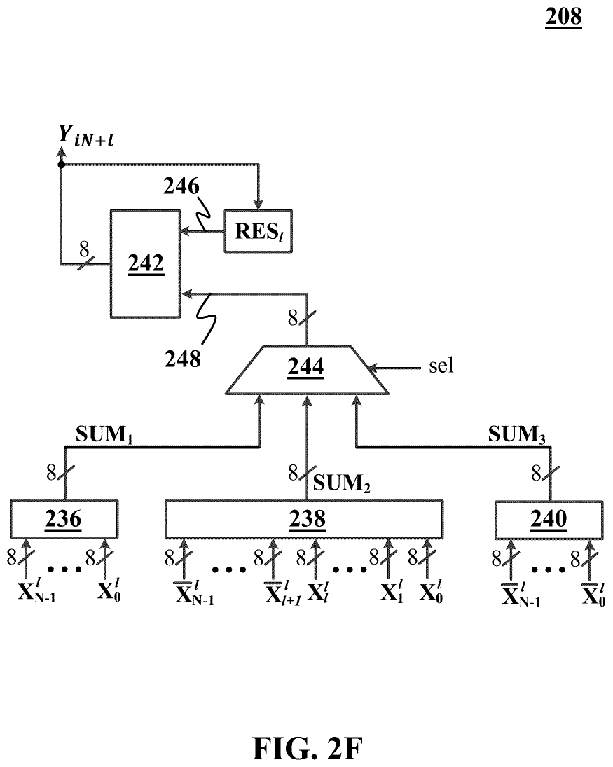

FIG. 2A shows a schematic of a logic circuit for anti-circular shift-and-add multiplication of an input vector and a binary vector, consistent with one or more exemplary embodiments of the present disclosure. An exemplary logic circuit 200 may perform an anti-circular shift-and-add multiplication on an input vector a and a binary vector b. In an exemplary embodiment, logic circuit 200 may include a plurality of input array pairs 202, a plurality of shift-and-add units 204, and an output datapath 206. An exemplary l^{th} shift-and-add unit 208 of plurality of shift-and-add units 204 may generate an l^{th} shift-and-add output Y_{iN+l} of a plurality of shift-and-add outputs 210 from an l^{th} input array pair (X^{l}, X̅^{l}) of plurality of input array pairs 202 at each clock cycle of logic circuit 200, where of 0≤l≤N−1 and N is an integer. For this purpose, in an exemplary embodiment, l^{th} shift-and-add unit 208 may receive l^{th} input array pair (X^{l}, X̅^{l}) at its input nodes and may perform a standard shift and add multiplication on l^{th} input array pair (X^{l}, X̅^{l}) and a load the multiplication result to l^{th} shift-and-add output Y_{lN+l}. In an exemplary embodiment, each of inputs X^{l} and X̅^{l} of l^{th} input array pair (X^{l}, X̅^{l}) may be provided by an AND gate array at its output nodes, as will be described later below. In an exemplary embodiment, output datapath 206 may generate an output vector OUTᵢ by merging plurality of shift-and-add outputs 210 into output vector OUTᵢ. In an exemplary embodiment, output datapath 206 may consist of databuses or registers that may be connected to plurality of shift-and-add outputs 210. In an exemplary embodiment, “merging” may refer to loading plurality of shift-and-add outputs 210 to exemplary databuses or registers in output datapath 206 that may form output vector OUTᵢ. In an exemplary embodiment, output vector OUTᵢ may include an (i+1)^{th} segment of a multiplication result a×b of input vector a and binary vector b where i is a first index and 0≤i<n/N where n is a multiple of N and represents a number of coefficients in input vector a and a number of bits in binary vector b. In an exemplary embodiment, binary vector b may be constant through an entire span of calculations and may be received from a memory before beginning an anti-circular shift-and-add multiplication.

In an exemplary embodiment, l^{th} input array pair (X^{l}, X̅^{l}) may include an l^{th} input array X^{l} and an l^{th} complemented input array X̅^{l}. In an exemplary embodiment, l^{th} input array X^{l} may include an l^{th} plurality of subarrays (X₀^{l}, . . . , X_{N-1}^{l}). In an exemplary embodiment, l^{th} complemented input array X̅^{l} may include an l^{th} plurality of complemented subarrays (x̅₀^{l}, . . . , X̅_{N-1}^{l}).

In an exemplary embodiment, logic circuit 200 may further include an input datapath 212. In an exemplary embodiment, input datapath 212 may be wired to N successive segments 214 of input vector a to receive N successive segments 214 at each clock cycle of logic circuit 200. In an exemplary embodiment, each of N successive segments 212 may include 8 successive bits of a corresponding coefficient in input vector a. For example, a first segment A₀ may include bits a[0] to a[7] of a coefficient a₀ in input vector a.

FIG. 2B shows a schematic of an input datapath, consistent with one or more exemplary embodiments of the present disclosure. Referring to FIGS. 2A and 2B, in an exemplary embodiment, input datapath 212 may receive a new (8×N)-bit data of input vector a in every clock cycle, which may contain N successive coefficients of a polynomial in R_{q}. Since, in an exemplary embodiment, input vector a may include n 8-bit coefficients, input datapath 212 may require n/N clock cycles to obtain all coefficients of input vector a. For example, for n=256 and N=4, it may take 8 clock cycles for input datapath 212 to obtain all coefficients of input vector a. In an exemplary embodiment, a second index j may be incremented once at each clock cycle from 0 to n/N−1 so that a j^{th} series of N coefficients may be obtained from input vector a in every clock cycle, as described in more detail below.

In an exemplary embodiment, input datapath 212 may include a plurality of two's complement converters 216. An exemplary k^{th} two's complement converter 218 of plurality of two's complement converters 216 may include an electronic circuit that may be configured to generate a k^{th} two's complement segment Āₖ of a plurality of two's complement segments (Ā₀, . . . , Ā_{N-1}) from a k^{th} segment Aₖ of N successive segments 214. In an exemplary embodiment, each of plurality of two's complement converters 216 may be configured to perform a two's complement operation on its input. For example, k^{th} two's complement converter 218 may negate k^{th} segment Aₖ to obtain k^{th} two's complement segment Āₖ by performing a two's complement operation on k^{th} segment Aₖ that may be wired to an input of k^{th} two's complement converter 218. In an exemplary embodiment, values of plurality of two's complement segments (Ā₀, . . . , Ā_{N-1}) may be configured to be calculated prior to starting operations of the anti-circular shift-and-add multiplication without any noticeable overhead.

Referring again to FIG. 2A, in an exemplary embodiment, logic circuit 200 may further include a counter 220. In an exemplary embodiment, counter 220 may refer to a sequential circuit that may increment second index j by one at each clock cycle of logic circuit 200. An exemplary clock signal clk may be connected to a clock input of counter 220 to trigger counter 220 at each clock cycle to increment an output of counter 220 that may include second index j. As a result, in an exemplary embodiment, a new series of N coefficients (a_{jN} to a_{jN+N-1} in FIG. 2B) may be obtained from input vector a in every clock cycle. Each exemplary series of N coefficients may correspond to a different value of second index j.

In an exemplary embodiment, counter 220 may further increment first index i by one at each clock cycle of logic circuit 200 responsive to second index j being equal to n/N. Therefore, in an exemplary embodiment, index i may be incremented at each clock cycle in which second index j reaches n/N. In an exemplary embodiment, counter 220 may further reset second index j to zero responsive to second index j being equal to n/N. Therefore, in an exemplary embodiment, index j may be reset to zero when reaching n/N. In other words, in an exemplary embodiment, calculation of the (i+1)^{th} segment of multiplication result a×b may be completed in n/N clock cycles, as described below.

In an exemplary embodiment, counter 220 may further reset first index i to zero responsive to first index i being equal to n/N. Therefore, in an exemplary embodiment, index i may be reset to zero when reaching n/N. As a result, a last segment of multiplication result a×b may be obtained for i=n/N−1.

In an exemplary embodiment, logic circuit 200 may further include a comparator 222. In an exemplary embodiment, comparator 222 may be configured to compare first index i with second index j and generate a first selection value sel₁ (for example, 0) at a comparator output sel responsive to first index i being larger than second index j. In an exemplary embodiment, comparator 222 may refer to an electronic circuit that receives first index i and second index j at its input nodes as electric signals loads an electric signal (such as a voltage signal) at its output (i.e., comparator output sel) according to the comparison result. For example, a low voltage (i.e., logic 0) may be generated at comparator output sel if first index i is smaller than second index j) or a high voltage (i.e., logic 1) may be generated at comparator output sel if first index i is larger than second index j). Therefore, in an exemplary embodiment, first selection value sel₁ may be generated at comparator output sel for i>j, which corresponds to the first scenario of the anti-circular shift-and-add multiplication described above.

In an exemplary embodiment, comparator 222 may further generate a second selection value sel₂ (for example, 1) at comparator output sel responsive to first index i being equal to second index j. Therefore, in an exemplary embodiment, second selection value sel₂ may be generated at comparator output sel for i=j, which corresponds to the second scenario of the anti-circular shift-and-add multiplication described above.

In an exemplary embodiment, comparator 222 may further generate a third selection value sel₃ (for example, 2) at comparator output sel responsive to first index i being smaller than second index j. Therefore, in an exemplary embodiment, third selection value sel₃ may be generated at comparator output sel for i<j, which corresponds to the third scenario of the anti-circular shift-and-add multiplication described above.

In an exemplary embodiment, logic circuit 200 may further include an input multiplexer 224. In an exemplary embodiment, input multiplexer 224 may refer to an electronic circuit that may generate a plurality of selected bits e from binary vector b by forwarding corresponding segments of binary vector b (that are connected to input nodes of input multiplexer 224) to its output nodes that may include plurality of selected bits e based on comparator output set. An exemplary (l+k)^{th} selected bit e[l+k] of plurality of selected bits e may be determined according to an operation defined by the following:

e[l+k]=b[N(i−j)−N+l+k+1] if sel=sel₁ Equation (1a)

b[l−k] for l≥k if sel=sel₂ Equation (1b)

b[n−k+l] for l<k if sel=sel₂ Equation (1c)

b[n−N(j−i)+l−k] if sel=sel₃ Equation (1d)
where 0≤k≤N−1 and b[m] represents an m^{th} bit of binary vector b. In an exemplary embodiment, Equation (1a) may describe selected bits of binary vector b for the first scenario of the anti-circular shift-and-add multiplication. In an exemplary embodiment, Equations (1a) and (1b) may describe selected bits of binary vector b for the second scenario of the anti-circular shift-and-add multiplication. In an exemplary embodiment, Equation (1d) may describe selected bits of binary vector b for the third scenario of the anti-circular shift-and-add multiplication. In an exemplary embodiment, plurality of selected bits e may be utilized to implement a corresponding scenario of the anti-circular shift-and-add multiplication, as described below.

In an exemplary embodiment, logic circuit 200 may further include a plurality of input registers 226. FIG. 2C shows a schematic of an input register, consistent with one or more exemplary embodiments of the present disclosure. Referring to FIGS. 2A and 2C, an exemplary (1+k)^{th} input register 226A of plurality of input registers 226 may include a plurality of input bits Eₗ₊ₖ. In an exemplary embodiment, each of plurality of input bits Eₗ₊ₖ may be coupled to (l+k)^{th} selected bit e[l+k] and may receive a value of (l+k)^{th} selected bit e[l+k]. In an exemplary embodiment, each of plurality of input registers 226 may include eight bits. As a result, in an exemplary embodiment, (l+k)^{th} input register 226A may include 8 copies of (l+k)^{th} selected bit e[l+k].

An exemplary logic circuit may further include an AND gate array 228. FIG. 2D shows a schematic of an AND gate array, consistent with one or more exemplary embodiments of the present disclosure. In an exemplary embodiment, AND gate array 228 may include a plurality of AND gate pairs. FIG. 2E shows a schematic of an AND gate pair, consistent with one or more exemplary embodiments of the present disclosure. An exemplary (l,k)^{th} AND gate pair 230 of the plurality of AND gate pairs may include a first AND gate 232 and a second AND gate 234. In an exemplary embodiment, first AND gate 232 may generate an (l,k)^{th} subarray Xₖ^{l} of l^{th} plurality of subarrays (X₀^{l}, . . . , X_{N-1}^{l}) by performing a bitwise AND operation on k^{th} segment Aₖ and a value of (l+k)^{th} input register 226A. An exemplary second AND gate may generate an (l,k)^{th} complemented subarray X̅ₖ^{l} of l^{th} plurality of complemented subarrays (X̅₀^{l}, . . . , X̅_{N-1}^{l}) by performing a bitwise AND operation on k^{th} two's complement segment Āₖ and (l+k)^{th} input register 226A. Referring to FIGS. 2B, 2C, and 2E, in an exemplary embodiment, values of (l,k)^{th} subarray Xₖ^{l} and (l,k)^{th} complemented subarray X̅ₖ^{l} may be given by the following:

Xₖ^{l}=a_{jN+k·}e[l+k] Equation (2a)

X̅ₖ^{l}=−a_{jN+k·}e[l+k] Equation (2b)

where a k is a k^{th} coefficient a value of (l+k)^{th} selected bit e[l+k] may be determined by Equations (1a)-(1d) according to one of the three scenarios of the anti-circular shift-and-add multiplication.

For further detail with respect to l^{th} shift-and-add unit 208, FIG. 2F shows a schematic of a shift-and-add unit, consistent with one or more exemplary embodiments of the present disclosure. In an exemplary embodiment, l^{th} shift-and-add unit 208 may include a first adder unit 236, a second adder unit 238, a third adder unit 240, a fourth adder unit 242, an l^{th} output register RES_{I} of a plurality of output registers RES, and a shift-and-add multiplexer 244. In an exemplary embodiment, an “adder unit” may refer to a digital circuit that may generate an addition of its inputs at its output. In an exemplary embodiment, a “register” may refer to an electronic circuit that may store its input data for at least one clock cycle.

In an exemplary embodiment, first adder unit 236 may generate a first adder output SUM₁ by summing values of each of l^{th} plurality of subarrays (X₀^{l}, . . . , X_{N-1}^{l}). As a result, in an exemplary embodiment, first adder unit 236 may implement the first scenario (corresponding to sel=sel₁ in Equation (1a) above) of the anti-circular shift-and-add multiplication, in which all selected coefficients may be summed. Referring to Equations (1a) and (2a), in an exemplary embodiment, first adder unit 236 may perform an operation according to the following:

$$\begin{matrix}{SUM}_{1} = {\sum }_{k = 0}^{N - 1} {X}_{k}^{l} = {\sum }_{k = 0}^{N - 1} {a}_{jN + k} \cdot e [ l + k ] \\ = {\sum }_{k = 0}^{N - 1} {a}_{jN + k} \cdot b [ N ( i - j ) - N + l + k + 1 ]\end{matrix} \qquad Equation ( 3 a )$$

In an exemplary embodiment, second adder unit 238 may implement the second scenario (corresponding to sel=sel₂ in Equations (1b) and (1c) above) of the anti-circular shift-and-add multiplication, which includes a mixed summation and subtraction of selected coefficients. Referring to Equations (1b), (1c), (2a), and (2b), in an exemplary embodiment, second adder unit 238 may generate a second adder output SUM 2 by performing an add operation defined by the following:

$$\begin{matrix}{SUM}_{2} = {\sum }_{k = 0}^{l} {X}_{k}^{l} + {\sum }_{k = l + 1}^{N - 1} {\overline{X}}_{k}^{l} \\ = {\sum }_{k = 0}^{l} {a}_{jN + k} \cdot e [ l + k ] - {\sum }_{k = l + 1}^{N - 1} {a}_{jn + k} \cdot e [ l + k ] \\ = {\sum }_{k = 0}^{l} {a}_{jN + k} \cdot b [ l - k ] - {\sum }_{k = l + 1}^{N - 1} {a}_{jN + k} \cdot b [ n - k + l ]\end{matrix} \qquad Equation ( 3 b )$$

In an exemplary embodiment, third adder unit 240 may generate a third adder output SUM₃ by summing values of each of l^{th} plurality of complemented subarrays (X̅₀^{l}, . . . , X̅_{N-1}^{l}). As a result, in an exemplary embodiment, third adder unit 240 may implement the third scenario (corresponding to sel=sel₃ in Equation (1d) above) of the anti-circular shift-and-add multiplication, in which all selected coefficients may be subtracted. Referring to Equations (1d) and (2b), in an exemplary embodiment, first adder unit 236 may perform an operation according to the following:

$$\begin{matrix}{SUM}_{3} = {\sum }_{k = 0}^{N - 1} {X}_{k}^{l} = {\sum }_{k = 0}^{N - 1} {a}_{jN + k} \cdot e [ l + k ] \\ = - {\sum }_{k = 0}^{N - 1} {a}_{jN + k} \cdot b [ n - N ( j - i ) + l - k ]\end{matrix} \qquad Equation ( 3 c )$$

In an exemplary embodiment, fourth adder unit 242 may include a first adder input 246 and a second adder input 248. In an exemplary embodiment, fourth adder unit 242 may generate l^{th} shift-and-add output Y_{iN+l} by adding first adder input 246 and second adder input 248.

In an exemplary embodiment, l^{th} output register RESₗ may store a value of l^{th} shift-and-add output Y_{iN+1} and load the value of l^{th} shift-and-add output Y_{iN+1} to first adder input 246 once at each clock cycle of logic circuit 200.

In an exemplary embodiment, shift-and-add multiplexer 244 may load first adder output SUM₁ to first adder input 246 responsive to comparator output sel being equal to first selection value sel₁. Therefore, in an exemplary embodiment, the value of l^{th} shift-and-add output Y_{iN+1} may be obtained for i>j (corresponding to the first scenario of the anti-circular shift-and-add multiplication) according to the following:

Y_{iN+l}⁺=Y_{iN+l}+SUM₁ Equation (4a)

where Y_{iN+l}⁺ denotes an updated value of l^{th} shift-and-add output Y_{iN+1}. In an exemplary embodiment, Y_{iN+l}⁺ may replace Y_{iN+l} in l^{th} output register RESₗ after obtaining Y_{iN+l}⁺ at each clock cycle of logic circuit 200.

In an exemplary embodiment, shift-and-add multiplexer 244 may further load second adder output SUM₂ to first adder input 246 responsive to comparator output sel being equal to second selection value sel₂. Therefore, in an exemplary embodiment, the value of l^{th} shift-and-add output Y_{iN+1} may be obtained for i=j (corresponding to the second scenario of the anti-circular shift-and-add multiplication) according to the following:

Y_{iN+l}⁺=Y_{iN+l}+SUM₂ Equation (4b)

In an exemplary embodiment, shift-and-add multiplexer 244 may further load third adder output SUM₃ to first adder input 246 responsive to comparator output sel being equal to third selection value sel₃. Therefore, in an exemplary embodiment, the value of l^{th} shift-and-add output Y_{iN+l} may be obtained for i<j (corresponding to the third scenario of the anti-circular shift-and-add multiplication) according to the following:

Y_{iN+l}⁺=Y_{iN+l}+SUM₃ Equation (4c)

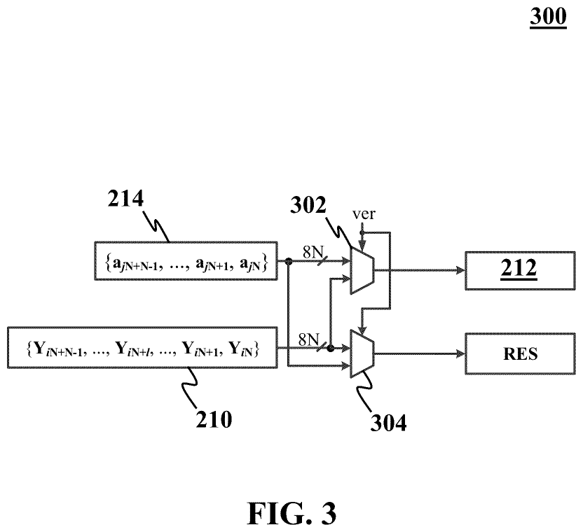

In an exemplary embodiment, logic circuit 200 may further include a fault detection unit (not illustrated in FIG. 2A). FIG. 3 shows a schematic of a fault detection unit, consistent with one or more exemplary embodiments of the present disclosure. An exemplary fault detection unit 300 may swap values of N successive segments 214 and plurality of shift-and-add outputs 210 once per two successive clock cycles to obtain a normal result (corresponding to a normal operation of logic circuit 200 as described above) and a swapped result (corresponding to the swapping of values of N successive segments 214 and plurality of shift-and-add outputs 210). In an exemplary embodiment, operations of logic circuit 200 if the normal result is equal to the swapped result. Details of fault detection unit 300 is described below.

In an exemplary embodiment, fault detection unit 300 may include a first verification multiplexer 302 and a second verification multiplexer 304. In an exemplary embodiment, first verification multiplexer 302 may refer to an electronic circuit that may load N successive segments 214 to input datapath 212 by forwarding N successive segments 214 to an output of verification multiplexer 302 that may be wired to input datapath 212 responsive to a verification bit ver being equal to a first binary value (for example, 0). In an exemplary embodiment, N successive segments 214 of FIG. 2A may be wired to a first input of first verification multiplexer 302. Therefore, in an exemplary embodiment, N successive segments 214 may be loaded to input datapath 212 when verification bit ver is equal to the first binary value, which may lead to the normal operation of logic circuit 200, as described above.

In an exemplary embodiment, first verification multiplexer 302 may further load values of plurality of shift-and-add outputs 210 to input datapath 212 by forwarding plurality of shift-and-add outputs 210 to the output of first verification multiplexer 302 that may be wired to input datapath 212 responsive to verification bit ver being equal to a second binary value (for example, 1). In an exemplary embodiment, plurality of shift-and-add outputs 210 of FIG. 2A may be wired to a second input of first verification multiplexer 302. Therefore, in an exemplary embodiment, plurality of shift-and-add outputs 210 may be loaded to input datapath 212 when verification bit ver is equal to the second binary value, which may lead to a swapped operation of logic circuit 200. In an exemplary embodiment, a value of verification bit ver may be inverted once at each clock cycle of logic circuit 200 (for example, by obtaining verification bit ver from an output of a T flip-flop that may have its output fed back to its input). As a result, in an exemplary embodiment, logic circuit 200 may switch from the normal operation to the swapped operation (and vice versa), at each clock cycle.

In an exemplary embodiment, second verification multiplexer 304 may refer to an electronic circuit that may load values of each shift-and-add output of plurality of shift-and-add outputs 210 to a respective output register of plurality of output registers RES by forwarding each shift-and-add output to an output of second verification multiplexer 304 that may be wired to a corresponding output register responsive to verification bit ver being equal to the first binary value. In an exemplary embodiment, plurality of shift-and-add outputs 210 of FIG. 2A may be wired to a first input of second verification multiplexer 304. Therefore, in an exemplary embodiment, plurality of shift-and-add outputs 210 may be loaded to plurality of output registers RES when verification bit ver is equal to the first binary value, which may lead to the normal operation of logic circuit 200, as described above.

In an exemplary embodiment, second verification multiplexer 304 may further load each respective value of each of N successive segments 214 to a respective output register of plurality of output registers RES by forwarding each of N successive segments 214 to the output of second verification multiplexer 304 that may be wired to a corresponding output register responsive to verification bit ver being equal to the second binary value. In an exemplary embodiment, N successive segments 214 of FIG. 2A may be wired to a second input of second verification multiplexer 304. Therefore, in an exemplary embodiment, N successive segments 214 may be loaded to plurality of output registers RES when verification bit ver is equal to the second binary value, which may lead to a swapped operation of logic circuit 200.

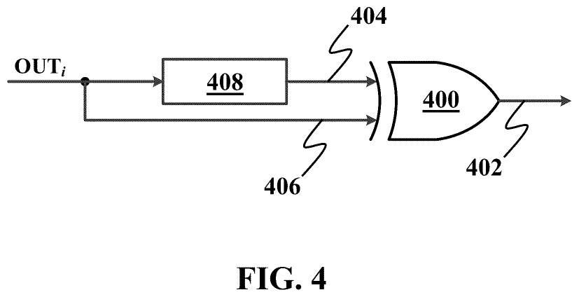

In an exemplary embodiment, logic circuit 200 may further include an XOR gate (not illustrated in FIG. 2A). FIG. 4 shows a schematic of an XOR gate loaded with two inputs, consistent with one or more exemplary embodiments of the present disclosure. An exemplary XOR gate 400 may generate a fault output 402 by performing a bitwise XOR operation on two successive values 404 and 406 of output vector OUTₗ. In an exemplary embodiment, output vector OUTᵢ may be wired to a first input of XOR gate 400. In an exemplary embodiment, two successive values 404 and 406 may be generated at output vector OUTᵢ at two successive clock cycles of logic circuit 200. An exemplary register 408 may store value 404 of output vector OUTᵢ for one clock cycle so that value 404 may be wired to a second input of XOR gate 400. As a result, value 404 may be XORed with value 406 that may be obtained one clock cycle after value 404. In an exemplary embodiment, fault output 402 may be zero if two successive values 404 and 406 of output vector OUTᵢ are equal, showing that results of logic circuit 200 may contain no errors. Otherwise, in an exemplary embodiment, it may be inferred that an error is present in output vector OUTᵢ.

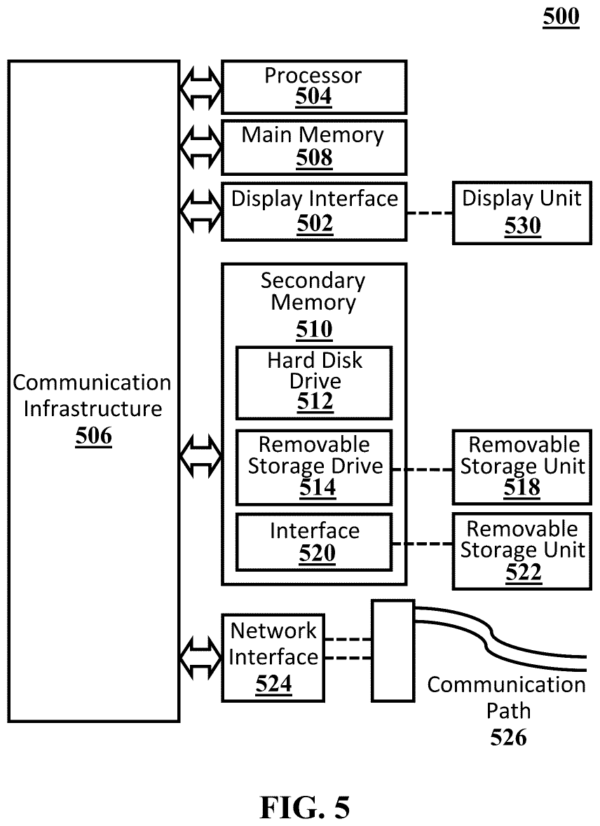

FIG. 5 shows an example computer system 500 in which an embodiment of the present invention, or portions thereof, may be implemented as computer-readable code, consistent with exemplary embodiments of the present disclosure. For example, input vector a and binary vector b may be stored in computer system 500 using hardware, software, firmware, tangible computer readable media having instructions stored thereon, or a combination thereof. Hardware, software, or any combination of such may embody any of the units and components in FIGS. 2A-4, for example, input vector a and binary vector b in FIGS. 2A, 2B, and 3.

If programmable logic is used, such logic may execute on a commercially available processing platform or a special purpose device. One ordinary skill in the art may appreciate that an embodiment of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, a computing device having at least one processor device and a memory may be used to implement the above-described embodiments. A processor device may be a single processor, a plurality of processors, or combinations thereof. Processor devices may have one or more processor “cores.”

An embodiment of the invention is described in terms of this example computer system 300. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose (e.g., a graphical processing unit) or a general-purpose processor device. As will be appreciated by persons skilled in the relevant art, processor device 504 may also be a single processor in a multi-core/multiprocessor system, such system operating alone, or in a cluster of computing devices operating in a cluster or server farm. Processor device 504 may be connected to a communication infrastructure 506, for example, a bus, message queue, network, or multi-core message-passing scheme.

In an exemplary embodiment, computer system 500 may include a display interface 502, for example a video connector, to transfer data to a display unit 530, for example, a monitor. Computer system 500 may also include a main memory 508, for example, random access memory (RAM), and may also include a secondary memory 510. Secondary memory 510 may include, for example, a hard disk drive 512, and a removable storage drive 514. Removable storage drive 514 may include a floppy disk drive, a magnetic tape drive, an optical disk drive, a flash memory, or the like. Removable storage drive 514 may read from and/or write to a removable storage unit 518 in a well-known manner. Removable storage unit 518 may include a floppy disk, a magnetic tape, an optical disk, etc., which may be read by and written to by removable storage drive 514. As will be appreciated by persons skilled in the relevant art, removable storage unit 518 may include a computer usable storage medium having stored therein computer software and/or data.

In alternative implementations, secondary memory 510 may include other similar means for allowing computer programs or other instructions to be loaded into computer system 500. Such means may include, for example, a removable storage unit 522 and an interface 520. Examples of such means may include a program cartridge and cartridge interface (such as that found in video game devices), a removable memory chip (such as an EPROM, or PROM) and associated socket, and other removable storage units 522 and interfaces 520 which allow software and data to be transferred from removable storage unit 522 to computer system 500.

Computer system 500 may also include a communications interface 524. Communications interface 524 allows software and data to be transferred between computer system 500 and external devices. Communications interface 524 may include a modem, a network interface (such as an Ethernet card), a communications port, a PCMCIA slot and card, or the like. Software and data transferred via communications interface 524 may be in the form of signals, which may be electronic, electromagnetic, optical, or other signals capable of being received by communications interface 524. These signals may be provided to communications interface 524 via a communications path 526. Communications path 526 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 518, removable storage unit 522, and a hard disk installed in hard disk drive 512. Computer program medium and computer usable medium may also refer to memories, such as main memory 508 and secondary memory 510, which may be memory semiconductors (e.g. DRAMs, etc.).

Computer programs (also called computer control logic) are stored in main memory 508 and/or secondary memory 510. Computer programs may also be received via communications interface 524. Such computer programs, when executed, enable computer system 500 to implement different embodiments of the present disclosure as discussed herein. In particular, the computer programs, when executed, enable processor device 504 to implement the processes of the present disclosure, such as sending input vector a and binary vector b to different elements of logic circuit 200 illustrated in FIGS. 2A-3 discussed above. Accordingly, such computer programs represent controllers of computer system 500. Where an exemplary embodiment of input vector a or binary vector b is implemented using software, the software may be stored in a computer program product and loaded into computer system 500 using removable storage drive 514, interface 520, and hard disk drive 512, or communications interface 524.

Embodiments of the present disclosure also may be directed to computer program products including software stored on any computer useable medium. Such software, when executed in one or more data processing device, causes a data processing device to operate as described herein. An embodiment of the present disclosure may employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations. This is for purposes of streamlining the disclosure, and is not to be interpreted as reflecting an intention that the claimed implementations require more features than are expressly recited in each claim. Rather, as the following claims reflect, inventive subject matter lies in less than all features of a single disclosed implementation. Thus, the following claims are hereby incorporated into the Detailed Description, with each claim standing on its own as a separately claimed subject matter.

While various implementations have been described, the description is intended to be exemplary, rather than limiting and it will be apparent to those of ordinary skill in the art that many more implementations and implementations are possible that are within the scope of the implementations. Although many possible combinations of features are shown in the accompanying figures and discussed in this detailed description, many other combinations of the disclosed features are possible. Any feature of any implementation may be used in combination with or substituted for any other feature or element in any other implementation unless specifically restricted. Therefore, it will be understood that any of the features shown and/or discussed in the present disclosure may be implemented together in any suitable combination. Accordingly, the implementations are not to be restricted except in light of the attached claims and their equivalents. Also, various modifications and changes may be made within the scope of the attached claims.

What is claimed is:

1. A logic circuit for anti-circular shift-and-add multiplication of an input vector a and a binary vector b, the logic circuit comprising:
a plurality of input array pairs;
a plurality of shift-and-add units, an l^{th} shift-and-add unit of the plurality of shift-and-add units configured to generate an l^{th} shift-and-add output of a plurality of shift-and-add outputs from an l^{th} input array pair of the plurality of input array pairs at each clock cycle of the logic circuit where of 0≤l≤N−1 and Nis an integer; and
an output datapath configured to generate an output vector by merging the plurality of shift-and-add outputs into the output vector, the output vector comprising an (i+1)^{th} segment of a multiplication result a×b of the input vector a and the binary vector b where i is a first index and 0≤i<n/N where n is a multiple of N and represents a number of bits of the binary vector b.

2. The logic circuit of claim 1, wherein the l^{th} input array pair comprises:
an l^{th} input array X^{l} comprising an l^{th} plurality of subarrays; and
an l^{th} complemented input array X̅^{l} comprising an l^{th} plurality of complemented subarrays.

3. The logic circuit of claim 2, further comprising a counter configured to:
increment a second index j by one at each clock cycle of the logic circuit;
increment the first index i by one at each clock cycle of the logic circuit responsive to the second index j being equal to n/N;
reset the first index i to zero responsive to the first index i being equal to n/N; and
reset the second index j to zero responsive to the second index j being equal to n/N.

4. The logic circuit of claim 3, further comprising a comparator configured to:
compare the first index i with the second index j;
generate a first selection value sel₁ at a comparator output sel responsive to the first index i being larger than the second index j;
generate a second selection value sel₂ at the comparator output sel responsive to the first index i being equal to the second index j; and
generate a third selection value sel₃ at the comparator output sel responsive to the first index i being smaller than the second index j.

5. The logic circuit of claim 4, further comprising an input multiplexer configured to generate a plurality of selected bits from the binary vector b based on the comparator output sel, an (l+k)^{th} selected bit e[l+k] of the plurality of selected bits determined according to an operation defined by the following:
e[l+k]=b[N(i−j)−N+l+k+1] if sel=sel₁,
b[l−k] for l≥k if sel=sel₂,
b[n−k+l] for l<k if sel=sel₂,
b[n−N(j−i)+l−k] if sel=sel₃,
where 0≤k≤N−1 and b[m] represents an m^{th} bit of the binary vector.

6. The logic circuit of claim 5, wherein the l^{th} shift-and-add unit comprises:
a first adder unit configured to generate a first adder output by summing values of each of the l^{th} plurality of subarrays;
a second adder unit configured to generate a second adder output by performing an add operation defined by the following:
$$S U {M}_{2} = {\sum }_{k = 0}^{l} {X}_{k}^{l} + {\sum }_{k = l + 1}^{N - 1} {\overline{X}}_{k}^{l}$$
where SUM₂ is the second adder output, Xₖ^{l} is an (l,k)^{th} subarray of the l^{th} plurality of subarrays, and X̅ₖ^{l} is an (l,k)^{th} complemented subarray of the l^{th} plurality of complemented subarrays;
a third adder unit configured to generate a third adder output by summing values of each of the l^{th} plurality of complemented subarrays;
a fourth adder unit comprising a first adder input and a second adder input, the fourth adder unit configured to generate the l^{th} shift-and-add output by adding the first adder input and the second adder input;
an l^{th} output register RESₗ of a plurality of output registers, the l^{th} output register RESₗ configured to:
store a value of the l^{th} shift-and-add output; and
load the value of the l^{th} shift-and-add output to the first adder input once at each clock cycle of the logic circuit; and
a shift-and-add multiplexer configured to:
load the first adder output to the first adder input responsive to the comparator output sel being equal to the first selection value sel₁;
load the second adder output to the first adder input responsive to the comparator output sel being equal to the second selection value sel₂; and
load the third adder output to the first adder input responsive to the comparator output sel being equal to the third selection value sel₃.

7. The logic circuit of claim 6, further comprising an input datapath configured to receive N successive segments of the input vector a at each clock cycle of the logic circuit, each of the N successive segments comprising 8 successive bits of the input vector a.

8. The logic circuit of claim 7, wherein the input datapath comprises a plurality of two's complement converters, a k^{th} two's complement converter of the plurality of two's complement converters configured to generate a k^{th} two's complement segment Āₖ of a plurality of two's complement segments from a k^{th} segment Aₖ of the N successive segments.

9. The logic circuit of claim 8, further comprising a plurality of input registers, an (l+k)^{th} input register Eₗ₊ₖ of the plurality of input registers comprising a plurality of input bits, each of the plurality of input bits coupled to the (l+k)^{th} selected bit e[l+k] and configured to receive a value of the (l+k)^{th} selected bit e[l+k].

10. The logic circuit of claim 9, further comprising an AND gate array, the AND gate array comprising a plurality of AND gate pairs, an (l,k)^{th} AND gate pair of the plurality of AND gate pairs comprising:
a first AND gate configured to generate the (l,k)^{th} subarray Xₖ^{l} by performing a bitwise AND operation on the k^{th} segment Aₖ and a value of the (l+k)^{th} input register Eₗ₊ₖ; and
a second AND gate configured to generate the (l,k)^{th} complemented subarray X̅ₖ^{l} by performing a bitwise AND operation on the k^{th} two's complement segment Āₖ and the (l+k)^{th} input register Eₗ₊ₖ.

11. The logic circuit of claim 10, further comprising:
a first verification multiplexer configured to:
load the N successive segments to the input datapath responsive to a verification bit being equal to a first binary value; and
load values of the plurality of shift-and-add outputs to the input datapath responsive to the verification bit being equal to a second binary value; and
a second verification multiplexer configured to:
load values of each shift-and-add output of the plurality of shift-and-add outputs to a respective output register of the plurality of output registers responsive to the verification bit being equal to the first binary value; and
load each respective value of each of the N successive segments to a respective output register of the plurality of output registers responsive to the verification bit being equal to the second binary value.

12. The logic circuit of claim 11, wherein a value of the verification bit is configured to be inverted once at each clock cycle of the logic circuit.

13. The logic circuit of claim 12, further comprising an XOR gate configured to generate a verification output by performing a bitwise XOR operation on two successive values of the output vector, the two successive values generated at the output vector at two successive clock cycles of the logic circuit.
